(19) United States
(12) Patent Application Publication
(10) Pub. No.: US 2012/0144450 A1
(43) Pub. Date: Jun. 7, 2012

(54) Authentication Method in Electronic Commerce

(75) Inventor: Helen Meng Pai, Taipei City (TW)

(73) Assignee: F2WARE, INC, San Jose, CA (US)

(21) Appl. No.: 13/026,297

(22) Filed: Feb. 14, 2011

(30) Foreign Application Priority Data
Dec. 6, 2010 (TW) 099142409

(51) Int. Cl. H04L 9/32

(52) U.S. Cl. 726/3

(57) ABSTRACT

An authentication method in electronic commerce is disclosed. The authentication method includes steps of a first side utilizing a first device to access an interactive interface, and the first side transferring a first device characteristics of the first device and a verification information to a second side for authentication.

### BACKGROUND OF THE INVENTION

1. Field of the Invention

The present invention relates to an authentication method in electronic commerce, and more particularly, to an authentication method capable of authenticating a user according to a device characteristics of a device utilized by the user.

2. Description of the Prior Art

In electronic commerce, a user usually needs to utilize a device, e.g. a computer, a mobile phone, to access to an interactive interface such as internet, telephone. Then, the user inputs verification information, e.g. credit card number, social security number, expiration date, card verification value etc., shared with a cash flow industry such as a bank, a credit card issuer, smartpay for authentication, so as to continue following operations.

For example, after a user utilizes a computer to access to an internet interface, if the user intends to utilize a credit card to transact in an online store, the user has to input an account, a password and verification information, such as credit card number, expiration date, card verification value, for the online store to authenticate the user. After the online store determines the inputted verification information is correct, the user is allowed to utilize the credit card to transact in the online store.

However, if the user carelessly visit a fake website and the account, the password and the verification information are stolen, or the credit card and a wallet is lost, such that the personal data and the verification information is utilized by someone to fraudulently register in an online store, it is very likely that the credit card is fraudulently used. Thus, there is a need for improvement of the prior art.

### SUMMARY OF THE INVENTION

It is therefore an objective of the present invention to provide an authentication method capable of authenticating a user according to a device characteristics of a device utilized by the user.

The present invention discloses an authentication method in electronic commerce. The authentication method includes steps of a first side utilizing a first device to access an interactive interface; and the first side transferring a first device characteristics of the first device and a verification information via the interactive interface to a second side for authentication.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an authentication process according to an embodiment of the present invention.

FIG. 2 is a schematic diagram of a credit card authentication process according to an embodiment of the present invention.

FIG. 3 is a schematic diagram of a credit card authentication process according to another embodiment of the present invention.

### DETAILED DESCRIPTION

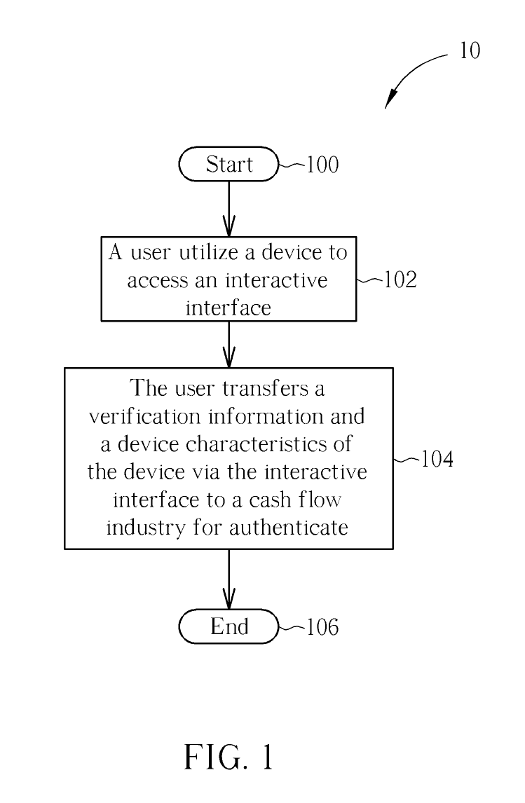

Please refer to FIG. 1, which is a schematic diagram of an authentication process 10 according to an embodiment of the present invention. The authentication process 10 is utilized in electronic commerce, and includes the following steps:

Step 100: Start.

Step 102: A user utilize a device to access an interactive interface.

Step 104: The user transfers a verification information and a device characteristics of the device via the interactive interface to a cash flow industry for authenticate.

Step 106: End.

According to the authentication process 10, in electronic commerce, the user has to utilize a device, e.g. a computer, a mobile phone, to access to an interactive interface, e.g. internet or telephone. Then, the user transfers a verification information and a device characteristics of the device utilized for accessing the interactive interface to a cash flow industry for authentication. As a result, the cash flow industry can authenticate the user according to the verification information and the device utilized for accessing the interactive interface, so as to enhance authentication security and avoid fraudulent use of a credit card or other shared verification information.

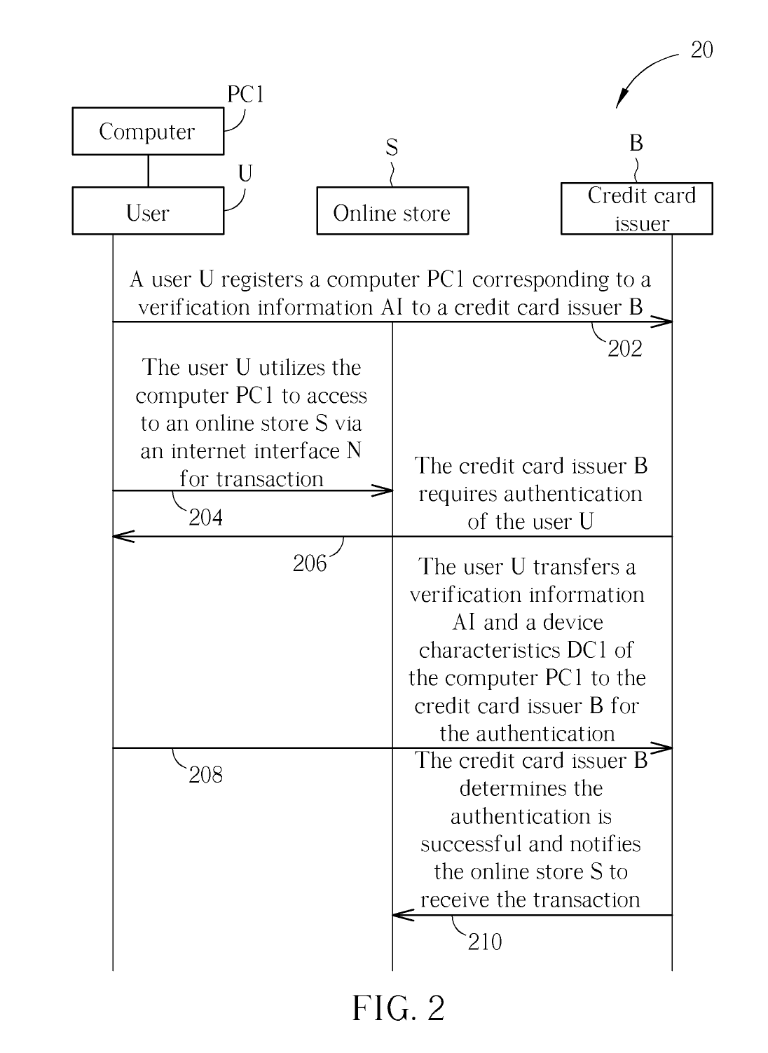

For example, please refer to FIG. 2, which is a schematic diagram of a credit card authentication process 20 according to an embodiment of the present invention. The credit card authentication process 20 is mainly utilized for specifically illustrating operations of each side, and those skilled in the art should make modifications or alterations according to the spirit of the present invention. The credit card authentication process 20 includes the following steps:

Step 202: A user U registers a computer PC1 corresponding to a verification information AI to a credit card issuer B.

Step 204: The user U utilizes the computer PC1 to access to an online store S via an internet interface N for transaction.

Step 206: The credit card issuer B requires authentication of the user U.

Step 208: The user U transfers a verification information AI and a device characteristics DC1 of the computer PC1 to the credit card issuer B for the authentication.

Step 210: The credit card issuer B determines the authentication is successful and notifies the online store S to receive the transaction.

According to the credit card authentication process 20, during application or activation of a credit card, the user U registers the computer PC1 (or a corresponding electronic mail address) corresponding to the verification information AI, such as credit card number, expiration date, card verification value, to the credit card issuer B. Then, when the user U utilizes the computer PC1 to access to the online store S via the internet interface N to transact on the online store S, the credit card issuer B requires authentication of the user U. Then, the user U transfers the verification information AI and the device characteristics DC1 of the computer PC1, such as browser, MAC address, application program, to the credit card issuer B for authentication. In such a situation, since the credit card issuer B can determine the computer PC1 is registered corresponding to the verification information AI according the device characteristics DC1, the credit card issuer B determines the authentication is successful and notifies the online store S to receive transaction. As a result, the user U can utilize the registered computer PC1 for the transaction.

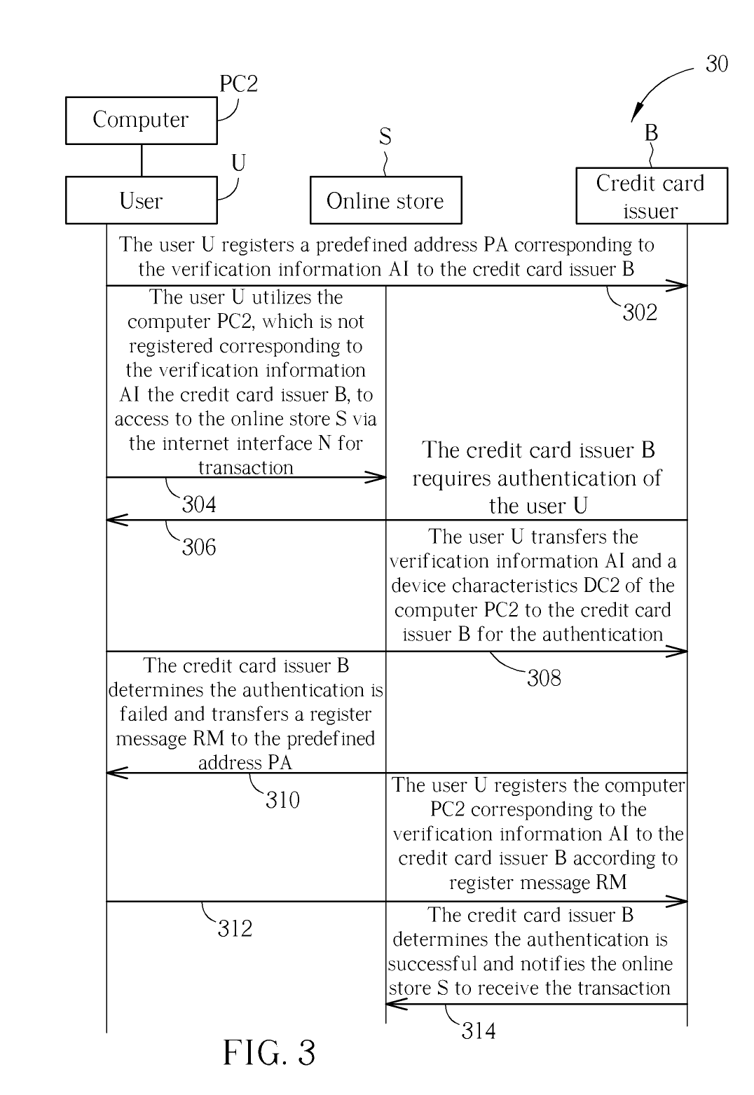

On the other hand, please refer to FIG. 3, which is a schematic diagram of a credit card authentication process 30 according to another embodiment of the present invention. A main difference between the credit card authentication process 30 and the credit card authentication process 20 is that the user U utilizes another computer PC2, which is not registered corresponding to the verification information AI the credit card issuer B, to access to the online store S via the internet interface N for transaction in the credit card authentication process 30. The credit card authentication process 30 includes the following steps:

Step 302: The user U registers a predefined address PA corresponding to the verification information AI to the credit card issuer B.

Step 304: The user U utilizes the computer PC2, which is not registered corresponding to the verification information AI the credit card issuer B, to access to the online store S via the internet interface N for transaction.

Step 306: The credit card issuer B requires authentication of the user U.

Step 308: The user U transfers the verification information AI and a device characteristics DC2 of the computer PC2 to the credit card issuer B for the authentication.

Step 310: The credit card issuer B determines the authentication is failed and transfers a register message RM to the predefined address PA.

Step 312: The user U registers the computer PC2 corresponding to the verification information AI to the credit card issuer B according to register message RM.

Step 314: The credit card issuer B determines the authentication is successful and notifies the online store S to receive the transaction.

As can be seen from the credit card authentication process 30, when the user U utilizes the computer PC2 to access to the online store S for transaction via the internet interface N, the credit card issuer B can determine the computer PC2 is not registered corresponding to the verification information AI according to the device characteristics DC2. Therefore, the credit card issuer B determines the authentication is failed and then transfers the register message RM to the predefined address PA such as a electronic mail address, which is registered corresponding to the verification information AI. Then, the user U has to register the computer PC2 corresponding to the verification information AI to the credit card issuer B according to the register message RM, such that the credit card issuer B can determine the authentication is successful and notifies the online store S to receive the transaction. In such a situation, when the user U intends to utilize the computer PC2 which not registered for transaction, the credit card issuer B transfers the register message RM to the predefined address PA first, and then the user U registers the computer PC2 according to the register message RM, so as to utilize the computer PC2 for the transaction.

As can be seen from the credit card authentication process 20 and the credit card authentication process 30, other than authenticating the general verification information AI, the credit card issuer B further requires the user U to utilize the registered computer PC1 for access or to register the computer PC2 utilized for access, so as to determine the authentication of the user U is successful. In such a situation, even if a fraudulent user acquires the verification information AI of the user U, the fraudulent user can not utilize the register computer PC1 for transaction, and also can not acquire the register message RM from the predefined address PA for register when utilizing the computer PC2, which is not registered, for transaction, wherein the user U can learn the credit card is fraudulent used from the register message RM. As a result, the present invention can authenticates user according to the verification information AI and the user U for access interactive interface of device, so as to increase authentication security and avoid fraudulent use.

Noticeably, the spirit of the present invention is that the cash flow industry can authenticate the user according to the verification information and the device characteristics of the device which the user utilizes to access the interactive interface, so as to increase authentication security and avoid fraudulent use. Those skilled in the art should make modifications or alterations accordingly. For example, the present invention is not limited to be applied in authentication of a credit card, and can be applied in authentication of other shared verification information, such as a social security number, an account. The interactive interface is not limited to internet, and can be other interactive interfaces such as telephone. The character performs authentication is not limited to the credit card issuer, and can be other cash flow industries such as bank, smartpay or other characters needs to authenticate the user. Other than transferring through the online store S to the credit card issuer B for authentication, the user U can directly transfer the verification information AI and the device characteristics DC1 or the device characteristics DC2 to the credit card issuer B for authentication, e.g. a browser popping up a new page to directly access the credit card issuer B, as long as the user U can output the verification information AI and the device characteristics DC1 or the device characteristics DC2 for authentication.

In addition, the device utilized for accessing the interactive interface is not limited to a computer, and can be other devices such as a mobile phone. The registered device and predefined address are not limited to be the same type as the device utilized for accessing the interactive interface, only if operations are correspondingly altered. For example, the predefined address PA utilized for receiving the verification information can be short message mail address of a registered mobile phone number. Therefore, when the user utilizes a computer, which is not registered, to access to the interactive interface, the cash flow industry can transfer the register message to the registered mobile phone number via a short message, such that the user can register the computer which is currently utilized. Noticeably, the predefined address PA can be any form capable of providing the user with the register message, and is not limited to the above electronic mail address or short message mail address.

Noticeably, realizations of each step of the above processes 10, 20, 30 should be known by those skilled in the art. For example, each step of the processes 10, 20, 30 can be can be compiled as units into a program or other operating methods by instructions, parameters, variables, etc. of specific programming languages, and be executed by corresponding devices utilized by each character in electronic commerce. The utilized devices are not limited to any form, e.g. software, hardware, firmware, and can be any device capable of executing the processes 10, 20, 30.

In the prior art, since only the online store authenticates the personal data and the verification information, the fraudulent user may steal the account, the password and the verification information, and fraudulently use the credit card. In comparison, the present invention can authenticate the user according to the verification information and the device utilized by the user to access the interactive interface. In such a situation, the user has to utilize the registered device for access or to register the device utilized for access, and then the credit card issuer would determine authentication is successful, which increases authentication security and avoid fraudulent use.

To sum up, the present invention can authenticate the user according to the verification information and the device utilized by the user to access the interactive interface, so as to increase authentication security and avoid fraudulent use.

Those skilled in the art will readily observe that numerous modifications and alterations of the device and method may be made while retaining the teachings of the invention.

What is claimed is:

1. An authentication method in electronic commerce, comprising:
a first side utilizing a first device to access an interactive interface; and
the first side transferring a first device characteristics of the first device and a verification information via the interactive interface to a second side for authentication.

2. The authentication method of claim 1, wherein the step of the first side transferring the first device characteristics of the first device and the verification information via the interactive interface to the second side for the authentication further comprises:
the first side transferring the first device characteristics of the first device and the verification information through a third side via the interactive interface to the second side for the authentication.

3. The authentication method of claim 1 further comprising:
the second side determining whether the first device is registered corresponding to the verification information according to the verification information and the first device characteristics for the authentication.

4. The authentication method of claim 3, wherein the step of the second side determining whether the first device is registered corresponding to the verification information according to the verification information and the first device characteristics for the authentication comprises:
the second side determining the authentication is successful when the first device is registered corresponding to the verification information.

5. The authentication method of claim 3, wherein the step of the second side determining whether the first device is registered corresponding to the verification information according to the verification information and the first device characteristics for the authentication comprises:
the second side determining the authentication is failed when the first device is not registered corresponding to the verification information.

6. The authentication method of claim 5 further comprising:
the second side transferring a register message to a predefined address corresponding to the verification information.

7. The authentication method of claim 6 further comprising:
the first side registering the first device corresponding to the verification information to the second side according to the register message.

8. The authentication method of claim 7 further comprising:
the second side determining the authentication is successful.

9. The authentication method of claim 1, wherein the interactive interface is an internet interface.

10. The authentication method of claim 1, wherein the interactive interface is a telephone interface.

11. The authentication method of claim 1, wherein the first side and the second side are a user and a cash flow industry, respectively.
